(19) United States
(12) Patent Application Publication
(10) Pub. No.: US 2007/0166653 A1
(43) Pub. Date: Jul. 19, 2007

(54) Vacuum level measurement apparatus and method

(76) Inventor: Jeffrey W. Jamison, Wappingers Falls, NY (US)

Correspondence Address: SCHMEISER, OLSEN & WATTS, 22 CENTURY HILL DRIVE, SUITE 302, LATHAM, NY, 12110, US

(21) Appl. No.: 11/333,600

(22) Filed: Jan. 16, 2006

(51) Int. Cl. A01G 13/06; F23L 7/00

(52) U.S. Cl. 431/18; 431/2

(57) ABSTRACT

An apparatus and method for measuring a vacuum level in a fuel oil line for an oil furnace. The apparatus comprises a measurement device, a first indicator, a second indicator, and an input device. The measurement device is for measuring a vacuum level in the fuel oil line. The fuel oil line is located between an output of a first oil storage apparatus and an input of a pump for the oil furnace. The first indicator is for indicating the vacuum level in the fuel oil line. The second indicator is for indicating a peak vacuum level of the vacuum level in the fuel oil line. The input device is for accepting a first specified vacuum level measurement set point.

### BACKGROUND OF THE INVENTION

1. Technical Field

The present invention relates to an apparatus and associated method for measuring vacuum levels in an oil furnace.

2. Related Art

An oil furnace typically does not provide much flexibility in detecting a furnace malfunction and providing a solution. Therefore, there is a need to provide more flexibility in the detection of a furnace malfunction and providing a solution.

### SUMMARY OF THE INVENTION

The present invention provides an apparatus, comprising:

a measurement device for measuring a vacuum level in a fuel oil line for an oil furnace, wherein said oil furnace comprises a pump for pumping oil into said oil furnace, and wherein said fuel oil line is located between an output of a first oil storage apparatus and an input of said pump;

a first indicator for indicating said vacuum level in said fuel oil line;

a second indicator for indicating a peak vacuum level of said vacuum level in said fuel oil line; and

an input device for accepting a first specified vacuum level measurement set point.

The present invention provides a method, comprising:

providing an apparatus comprising, a measurement device, a first indicator, a second indicator, and an input device;

measuring, by said measurement device, a vacuum level in a fuel oil line for an oil furnace, wherein said oil furnace comprises a pump for pumping oil into said oil furnace, and wherein said fuel oil line is located between an output of a first oil storage apparatus and an input of said pump;

indicating by said first indicator, said vacuum level in said fuel oil line;

indicating, by said second indicator, a peak vacuum level of said vacuum level in said fuel oil line; and

accepting, by said input device, a first specified vacuum level measurement set point.

The present invention advantageously provides more flexibility in the detection of a furnace malfunction and providing a solution.

### BRIEF DESCRIPTION OF THE DRAWINGS

FIG. 1 depicts a block diagram of a system comprising a vacuum level measurement apparatus connected to an oil furnace, in accordance with embodiments of the present invention.

FIG. 2 illustrates a first variation of FIG. 1, in accordance with embodiments of the present invention.

FIG. 3 illustrates a second variation of FIG. 1, in accordance with embodiments of the present invention.

FIG. 4 illustrates a third variation of FIG. 1, in accordance with embodiments of the present invention.

FIG. 5 illustrates a first variation of FIG. 4, in accordance with embodiments of the present invention.

FIG. 6 illustrates a second variation of FIG. 4, in accordance with embodiments of the present invention.

FIG. 7 illustrates an analog version of a vacuum level measurement apparatus, in accordance with embodiments of the present invention.

FIG. 8 illustrates a digital version of a vacuum level measurement apparatus, in accordance with embodiments of the present invention.

### DETAILED DESCRIPTION OF THE INVENTION

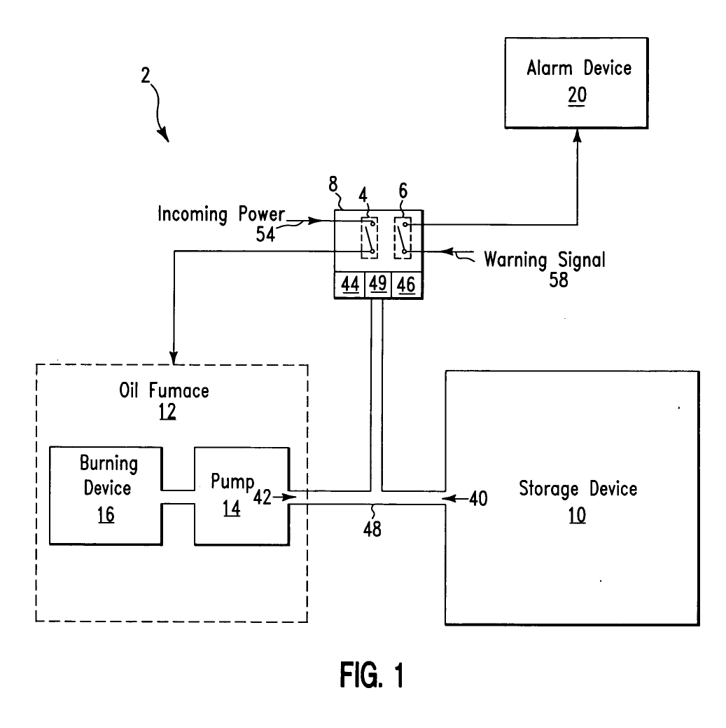

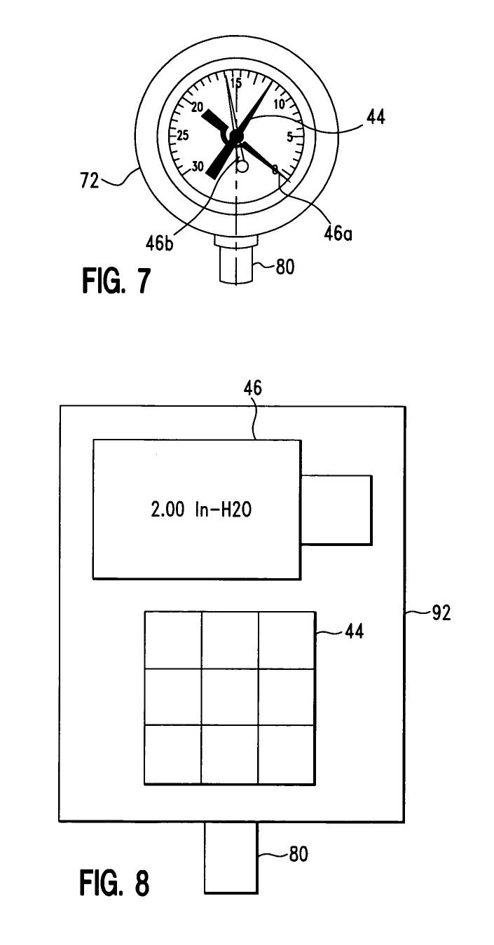

FIG. 1 depicts a block diagram of a system 2 comprising a vacuum level measurement apparatus 8 connected to an oil furnace 12, in accordance with embodiments of the present invention. The vacuum level measurement apparatus 8 comprises a measurement device 49, switches 4 and 6, an input device 44, and an indicator 46. The system 2 comprises an oil furnace 12, a storage device 10, the vacuum level measurement apparatus 8, and an alarm device 20. The oil furnace 12 comprises a pump 14 and a burning device 16. The pump 14 transfers fuel oil from the storage device 10 to the burning device 16. The burning device 16 is adapted to pressurize and combine the fuel oil with air. The fuel oil/air mixture is sprayed as a fine mist and ignited by a spark thereby creating a flame for heating a heat exchanger. The oil furnace 12 may be any type of oil furnace known to a person of ordinary skill in the art. The burning device 16 may be any oil furnace burner known to a person of ordinary skill in the art. The vacuum level measurement apparatus 8 is adapted to measure a vacuum level within a fuel oil line 48 between an output 40 of the storage device and an input 42 of the pump. The vacuum level measurement apparatus 8 may be connected to the fuel oil line 48. Alternatively, the vacuum level measurement apparatus 8 may be located within the pump 14. The vacuum level measurement apparatus 8 may comprise an analog measurement apparatus (e.g., see FIG. 7) or a digital measurement apparatus (e.g., see FIG. 8). The vacuum level measurement apparatus 8 is adapted measure and indicate or display a real time vacuum level and a peak vacuum level within the fuel oil line 48. The measurement device 49, measures the vacuum level and the indicator 46 indicates or displays the real time vacuum level and the peak vacuum level within the fuel oil line 48. The measurement device 49 may comprise any type of vacuum level measurement device including, inter alia, a transducer, a diaphragm, etc. The indicator 46 may comprise a single indicator such as, inter alia, a digital display (e.g., a liquid crystal display (LCD), a light emitting diode display (LED)), an analog display (e.g., a gauge needle as shown in FIG. 7), etc. Alternatively, the indicator 46 may comprise a plurality of indicators such as, inter alia, a plurality of digital displays (e.g., a liquid crystal display (LCD), a light emitting diode display (LED)), a plurality of analog displays (e.g., gauge needles as shown in FIG. 7), etc. As the measurement device 49 measures the vacuum level within the fuel oil line 48, the indicator 46 displays the vacuum level in real time. If the measurement device 49 measures a first peak vacuum level (i.e., a vacuum level that is greater than any other vacuum level that has been measured by the measurement device 49 and indicated by the indicator 46) within the fuel oil line 48, the indicator 46 will indicate/display and hold the first peak vacuum level until either a second peak vacuum level (i.e., the second peak vacuum level comprises a greater vacuum level that the first peak vacuum level) is achieved or the indicator is reset. The peak vacuum level is displayed and/or held so that a user may view a peak vacuum level over a period of time. Alternatively, the vacuum level measurement apparatus 8 (i.e., in a digital configuration) may measure a first peak vacuum level within the fuel oil line 48 and store the first peak vacuum level within a memory unit (i.e., within the vacuum level measurement apparatus 8) so that a user may retrieve and display (i.e., on the indicator 46) the first peak vacuum level at any time. Additionally, the vacuum level measurement apparatus 8 (i.e., in a digital configuration) may measure a plurality of peak vacuum levels within the fuel oil line 48 and store the plurality of peak vacuum levels within a memory unit (i.e., within the vacuum level measurement apparatus 8) so that a user may retrieve and display (i.e., on the indicator 46) the plurality of peak vacuum levels at any time.

The vacuum level measurement apparatus 8 is adapted to disable incoming power 54 to the oil furnace 12 based on a specified vacuum level measurement. The vacuum level measurement apparatus comprises a switch 4 that is normally closed (N/C) so that a signal path is maintained until the switch 4 is activated. Under normal conditions the incoming power 54 from a fuse panel or any other power source is transmitted through the switch 4 to energize the oil furnace 12. The incoming power 54 may comprise, inter alia, alternating current (AC) or direct current (DC), etc. The vacuum level measurement apparatus 8 comprises an input device 44 for accepting a first specified vacuum level measurement set point so that when a vacuum level measured by the measurement device is equivalent to or exceeds the first specified vacuum level measurement set point, the switch 4 opens thereby disabling the incoming power 54 to the oil furnace. The switch 4 may be a latching switch so that the incoming power 54 to the oil furnace 12 remains disabled until the switch 4 is reset. The vacuum level measurement apparatus 8 may additionally comprise a second switch 6 that is normally open (N/O) so that a signal path is interrupted until the switch 6 is activated. Under normal conditions a warning signal 56 from a fuse panel or any other power source is unable to pass through the switch 6. The warning signal 56 may be, inter alia, a control signal. The warning signal 56 may comprise, inter alia, alternating current (AC) or direct current (DC), etc. The input device 44 may be used to accept a second specified vacuum level measurement set point so that when a vacuum level measured by the vacuum level measurement apparatus 8 is equivalent to or exceeds the second specified vacuum level measurement set point, the second switch 6 closes thereby enabling the warning signal 56 to an alarm device 20. The alarm device 20 informs a user that there is a problem with the oil furnace 12. The second switch 6 may be a latching switch so that the warning signal 56 to the alarm device remains enabled until the second switch 6 is reset. The switch 4 and the switch 6 may be any switch known to a person of ordinary skill in the art including, inter alia, a relay, a contactor, etc. The relay may be any relay known to a person of ordinary skill in the art including, inter alia, a mechanical relay, a solid state relay (SSR), a latching relay (mechanical or SSR), a timer relay (mechanical or SSR), etc. The vacuum level may be measured in any units known to a person of ordinary skill in the art such as, inter alia, inches of water, feet of water, inches of mercury, millimeters of mercury, etc. The first specified vacuum level measurement set point may be selected from a range of about 5 inches of water to about 15 inches of water. The second specified vacuum level measurement set point may be selected from a range of about 4 inches of water to about 20 inches of water. The first specified vacuum level measurement set point may be set at a lower vacuum level measurement than the second specified vacuum level measurement set point so that the alarm device 20 informs the user that there is a problem with the oil furnace after the furnace is shut down. Alternatively, the first specified vacuum level measurement set point may be set at a higher vacuum level measurement than the second specified vacuum level measurement set point so that the alarm device 20 informs the user that there is a problem with the oil furnace before the furnace is shut down. The alarm device 20 may be any alarm device known to a person of ordinary skill in the art such as, inter alia, a home security system, a bell, a flashing light, etc.

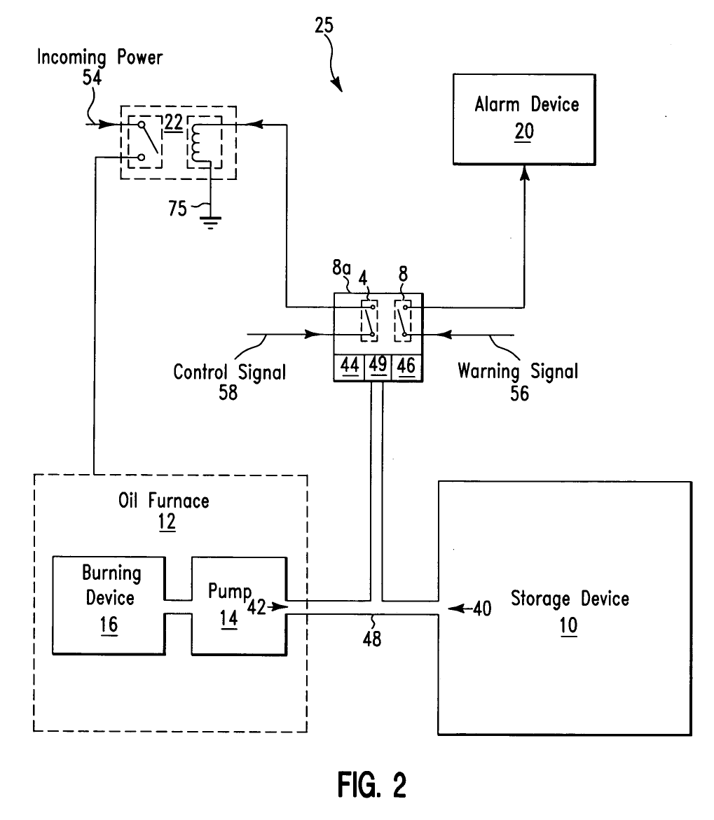

FIG. 2 illustrates a first variation of FIG. 1 depicting a block diagram of a system 25 comprising a vacuum level measurement apparatus 8a connected to the oil furnace 12, in accordance with embodiments of the present invention. The system 25 comprises the oil furnace 12, the storage device 10, the vacuum level measurement apparatus 8a, a switching apparatus 22, and the alarm device 20. In contrast with FIG. 1, the switch 4 is normally open so that a signal path is interrupted until the switch 4 is activated. Under normal conditions a control signal 58 from a fuse panel or any other power source is unable to pass through the switch 4. The control signal 58 may comprise, inter alia, alternating current (AC) or direct current (DC), etc. Additionally, FIG. 2 comprises the switching apparatus 22 for switching the incoming power 54 to the oil furnace 12. The switching apparatus 22 is normally closed so that a signal path for the incoming power 54 to the furnace is maintained until the switching apparatus 22 is activated. When a vacuum level measurement is equivalent to or exceeds the first specified vacuum level measurement set point, the switch 4 closes thereby enabling the control signal 58 to activate the switching apparatus 22 and ultimately disabling the incoming power 54 to the furnace. The switching apparatus 22 may be a latching switching apparatus so that the incoming power 54 to the oil furnace 12 remains disabled until the switching apparatus 22 is reset. If the control signal 58 is a positive DC signal then a signal 75 is a DC ground or negative signal related to the control signal 58. If the control signal 58 is a hot AC signal then the signal 75 is an AC neutral signal related to the control signal 58. The switching apparatus 22 may be any switching apparatus known to a person of ordinary skill in the art including, inter alia, a relay, a contactor, etc. The relay may be any relay known to a person of ordinary skill in the art including, inter alia, a mechanical relay, a solid state relay (SSR), a latching relay (mechanical or SSR), a timer relay (mechanical or SSR), etc. The contactor may be, inter alia, a latching contactor. Although the vacuum level measurement apparatus 8a and the switching apparatus 22 are illustrated as separate components, note that the vacuum level measurement apparatus 8a may comprise the switching apparatus 22 (i.e., the switching apparatus 22 may be built in to or a part of the vacuum level measurement apparatus 8a).

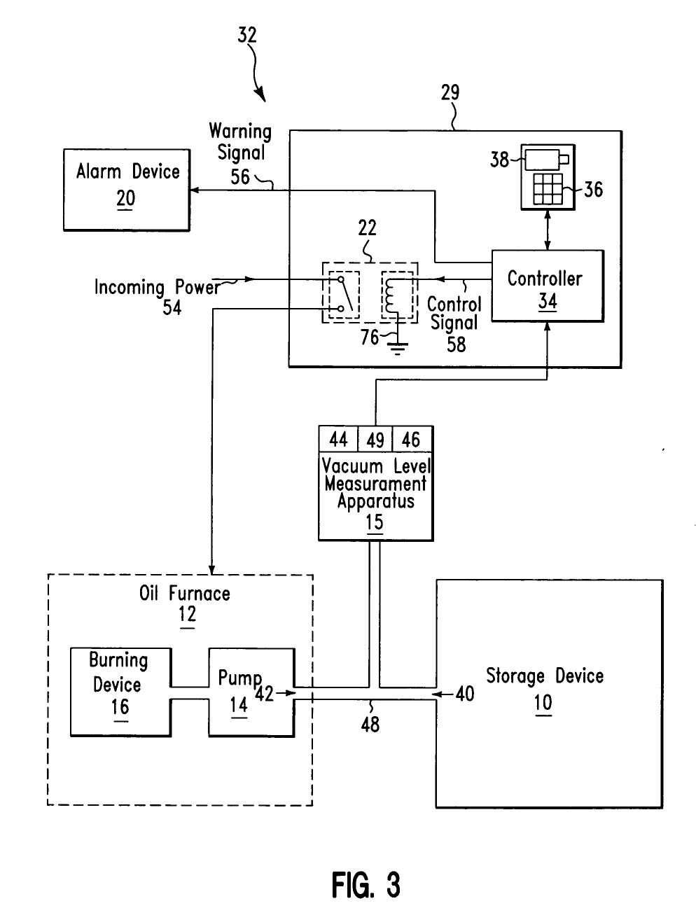

FIG. 3 illustrates a second variation of FIG. 1 depicting a block diagram of a system 32 comprising a vacuum level measurement apparatus 15 connected to the oil furnace 2, in accordance with embodiments of the present invention. In contrast with FIG. 1, the system 32 comprises vacuum level measurement apparatus 15 and a control system 29. The control system 29 comprises an input device 36, an output device 38, a controller 34, and a switching apparatus 22. Under normal conditions the incoming power 54 from a fuse panel or any other power source is transmitted through the switching apparatus 22 to energize the oil furnace 12. The switching apparatus 22 is normally closed (N/C) so that a signal path for the incoming power 54 to the furnace is maintained until the switching apparatus 22 is activated. The controller 34 may comprise a microprocessor and a signal conditioning device (e.g., Analog/Digital converter, Digital/Analog converter, DC/DC converter, etc.). The vacuum level measurement apparatus 15 is adapted to convert a vacuum level measured by the measurement device 49 to a first electrical signal and transmit the first electrical signal to the controller 34 within the control system 29. The input device 36 and/or the input device 44 is adapted to accept and transmit the first vacuum level measurement set point of FIG. 1 to the controller 34. The controller 34 is adapted to convert the first specified vacuum level measurement set point to a second electrical signal. Additionally, the controller 34 is adapted to compare at least one level of the first electrical signal to a level of the second electrical signal and create a first control signal 58 when the at least one level of the first electrical signal is equivalent to or exceeds the level of the second electrical signal. The first control signal 58 activates the switching apparatus 22 thereby disabling the incoming power 54 to the furnace 12. The switching apparatus 22 may be a latching switching apparatus so that the incoming power 54 to the oil furnace 12 remains disabled until the switching apparatus 22 is reset. If the control signal 58 is a positive DC signal then a signal 75 is a DC ground or negative signal related to the control signal 58. If the control signal 58 is a hot AC signal then the signal 75 is an AC neutral signal related to the control signal 58. The switching apparatus 22 may be any switching apparatus known to a person of ordinary skill in the art including, inter alia, a relay, a contactor, etc. The relay may be any relay known to a person of ordinary skill in the art including, inter alia, a mechanical relay, a solid state relay (SSR), a latching relay (mechanical or SSR), a timer relay (mechanical or SSR), etc. The contactor may be, inter alia, a latching contactor. The input device 36 and/or the input device 44 is further adapted to accept and transmit the second vacuum level measurement set point of FIG. 1 to the controller 34. The controller 34 is adapted to convert the second specified vacuum level measurement set point to a third electrical signal. Additionally, the controller 34 is further adapted to compare a level of the third electrical signal to the at least one level of the first electrical signal 60 and transmit a warning signal 56 to an alarm device 20 when the at least one level of the first electrical signal 60 is equivalent to or exceeds the level of the third electrical signal. The warning signal 56 activates the alarm device 20. The output device 38 is adapted to display the first vacuum level measurement set point and the second vacuum level measurement set point. The output device 38 may be any output device known to a person of ordinary skill in the art including, inter alia, a liquid crystal display (LCD), a light emitting diode (LED), a cathode ray tube (CRT), etc. The input device 36 may be any input device known to a person of ordinary skill in the art including, inter alia, a keypad, a key board, etc. The measurement device 49 may be any measurement device known to a person of ordinary skill in the art including, inter alia, a transducer, etc. The first electrical signal, the second electrical signal, and the third electrical signal may be, inter alia, a voltage signal or a current signal. Although the vacuum level measurement apparatus 15 and the control system 29 are illustrated as separate components, note that the vacuum level measurement apparatus 15 may comprise the control system 29 (i.e., the control system 29 may be built in to or a part of the vacuum level measurement apparatus 15).

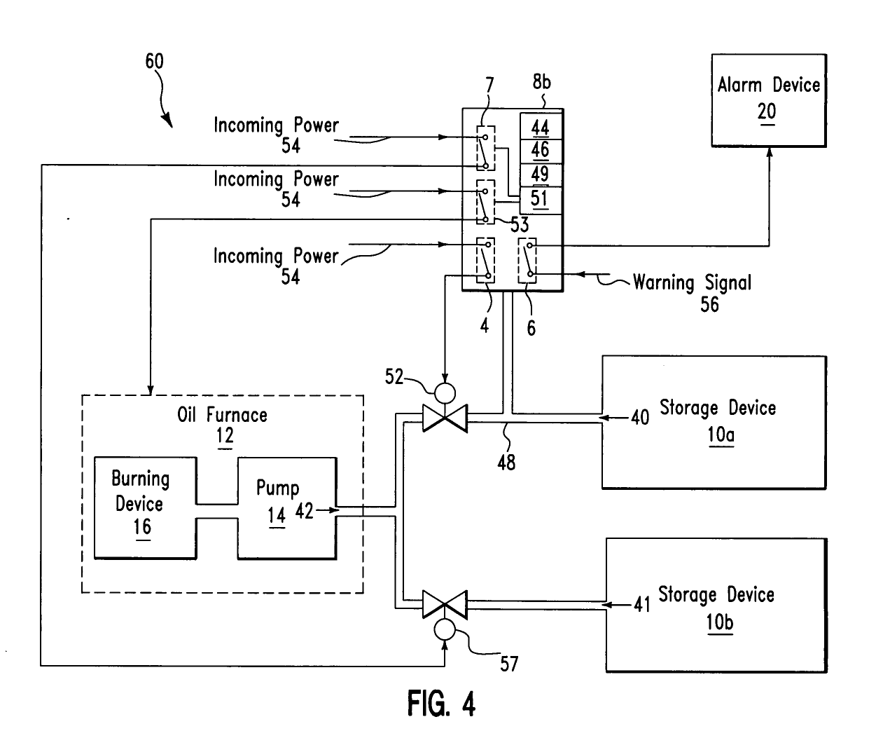

FIG. 4 illustrates a third variation of FIG. 1 depicting a block diagram of a system 60 comprising a vacuum level measurement apparatus 8b connected to the oil furnace 12, in accordance with embodiments of the present invention. In contrast with FIG. 1, the system 60 of FIG. 4, comprises storage devices 10a and 10b, the vacuum level measurement apparatus 8b, and solenoid valves 52 and 57. The system 60 allows for an oil flow from storage device 10a to be disabled and an oil flow from storage device 10b to be enabled in the event that a malfunction occurs within the storage device 10a (e.g., storage device 10a empty, clog in output 40, etc) or the fuel oil line 48 (e.g., clogged). The vacuum level measurement apparatus 8b of FIG. 4 comprises switches 4, 6, and, 7. Additionally, the vacuum level measurement apparatus 8b of FIG. 4 may comprise a switch 53 and a timer 51 as described, infra. The system 60 comprises a plurality of storage devices (i.e., oil storage device 10a and 10b) and solenoid valves 52 and 57. The pump 14 transfers fuel oil from either storage device 10a or storage device 10b (i.e., depending on which of solenoid valves 52 or 57 is open) to the burning device 16. The vacuum level measurement apparatus 8b is adapted to measure a vacuum level within a fuel oil line 48 between an output 40 of the storage device 10a and an input 42 of the pump. The vacuum level measurement apparatus 8 may be connected to the fuel oil line 48. Alternatively, the vacuum level measurement apparatus 8 may be located within the pump 14. The vacuum level measurement apparatus 8b may comprise an analog measurement apparatus (e.g., see FIG. 7) or a digital measurement apparatus (e.g., see FIG. 8). The vacuum level measurement apparatus 8 is adapted measure and indicate or display a real time vacuum level and a peak vacuum level within the fuel oil line 48.

The solenoid valves 52 and 57 are normally closed (N/C) valves (i.e., do not allow for oil flow) until a power signal (e.g., incoming power 54) is applied (i.e., solenoid valve 52 or 57 is energized). The vacuum level measurement apparatus 8b is adapted to enable incoming power 54 to either solenoid valve 52 or solenoid valve 57 based on a specified vacuum level measurement. The vacuum level measurement apparatus 8b comprises switch 4 that is normally closed (N/C) so that a signal path is maintained until the switch 4 is activated and switch 7 that is normally open (N/O) so that a signal path is disabled until the switch 7 is activated. Under normal conditions the incoming power 54 from a fuse panel or any other power source is transmitted through the switch 4 to energize the solenoid valve 52 so that oil may flow from storage device 10a to the pump 14. The switch 7 remains open so that solenoid valve 57 remains closed thereby disabling oil flow from the storage device 10b. The incoming power 54 may comprise, inter alia, alternating current (AC) or direct current (DC), etc. The vacuum level measurement apparatus 8 comprises the input device 44 for accepting a first specified vacuum level measurement set point so that when a vacuum level measured by the measurement device 49 is equivalent to or exceeds the first specified vacuum level measurement set point, the switch 4 opens thereby disabling the incoming power 54 to the solenoid valve 52 and the switch 7 closes thereby enabling the incoming power 54 to the solenoid valve 57. The aforementioned sequence of events disables a flow of oil from storage device 10a to the pump 14 and enables a flow of oil from the storage device 10b to the pump 14. The switch 4 may be a latching switch so that the incoming power 54 to the storage device 10a remains disabled until the switch 4 is reset.

The vacuum level measurement apparatus 8b of FIG. 4 may additionally comprise a switch 53 and a timer 51. The switch 53 is normally closed (N/C) so that a signal path is maintained until the switch 53. Under normal conditions, the incoming power 54 from a fuse panel or any other power source is transmitted through the switch 4 to energize the solenoid valve 52 so that oil may flow from storage device 10a to the pump 14. Additionally, the incoming power 54 from a fuse panel or any other power source is transmitted through the switch 53 to energize the furnace. The switch 7 remains open so that solenoid valve 57 remains closed thereby disabling oil flow from the storage device 10b. When a vacuum level measured by the measurement device 49 is equivalent to or exceeds the first specified vacuum level measurement set point, the switch 4 opens thereby disabling the incoming power 54 to the solenoid valve 52. Additionally, the switch 53 opens thereby disabling the incoming power 54 to the oil furnace 12. The timer 51 maintains the switch 53 and the switch 7 in an open position for a specified time period (i.e., the specified time period is programmed on the timer 51 by a user) so that the furnace is powered down and there is no oil flow for the specified time period. The aforementioned process allows the system 60 to be shut down for the specified time period programmed on the timer 51 so that additional problems with the system 60 may be avoided. For example, the system 60 may be shut down for a specified time period to allow any sludge that may be floating around in the storage device 10b to settle before flowing oil from the storage device 10b to the oil furnace 12. After the specified time period programmed on the timer 51 has elapsed, the switch 53 and the switch 7 closes thereby enabling the incoming power 54 to the oil furnace 12 and the solenoid valve 57. The aforementioned sequence of events disables a flow of oil from storage device 10a to the pump 14, disables power to the furnace for a specified time period, and enables a flow of oil from the storage device 10b to the pump 14 after the specified amount of time programmed on the timer 51 has elapsed. The specified time period may comprise a time period of about 1 minute to about 3 hours.

The vacuum level measurement apparatus 8b may additionally comprise a switch 6 that is normally open (N/O) so that a signal path is interrupted until the switch 6 is activated. Under normal conditions a warning signal 56 from a fuse panel or any other power source is unable to pass through the switch 6. The warning signal 56 may be, inter alia, a control signal. The warning signal 56 may comprise, inter alia, alternating current (AC) or direct current (DC), etc. The input device 44 may be used to for accept a second specified vacuum level measurement set point so that when a vacuum level measured by the vacuum level measurement apparatus 8 is equivalent to or exceeds the second specified vacuum level measurement set point, the second switch 6 closes thereby enabling the warning signal 56 to an alarm device 20. The alarm device 20 informs a user that there is a problem with the storage device 10a or the fuel oil line 48. The switch 6 may be a latching switch so that the warning signal 56 to the alarm device remains enabled until the second switch 6 is reset. The switch 4, the switch 6, and the switch 7 may be any switch known to a person of ordinary skill in the art including, inter alia, a relay, a contactor, etc. The relay may be any relay known to a person of ordinary skill in the art including, inter alia, a mechanical relay, a solid state relay (SSR), a latching relay (mechanical or SSR), a timer relay (mechanical or SSR), etc. The vacuum level may be measured in any units known to a person of ordinary skill in the art such as, inter alia, inches of water, feet of water, inches of mercury, millimeters of mercury, etc. The first specified vacuum level measurement set point may be selected from a range of about 5 inches of water to about 15 inches of water. The second specified vacuum level measurement set point may be selected from a range of about 4 inches of water to about 20 inches of water. The first specified vacuum level measurement set point may be set at a lower vacuum level measurement than the second specified vacuum level measurement set point so that the alarm device 20 informs the user that there is a problem with the storage device 10a or the fuel oil line 48 after a flow of oil from storage device 10a is disabled. Alternatively, the first specified vacuum level measurement set point may be set at a higher vacuum level measurement than the second specified vacuum level measurement set point so that the alarm device 20 informs the user that there is a problem with the storage device 10a or the fuel oil line 48 before storage device 10a is disabled. The alarm device 20 may be any alarm device known to a person of ordinary skill in the art such as, inter alia, a home security system, a bell, a flashing light, etc.

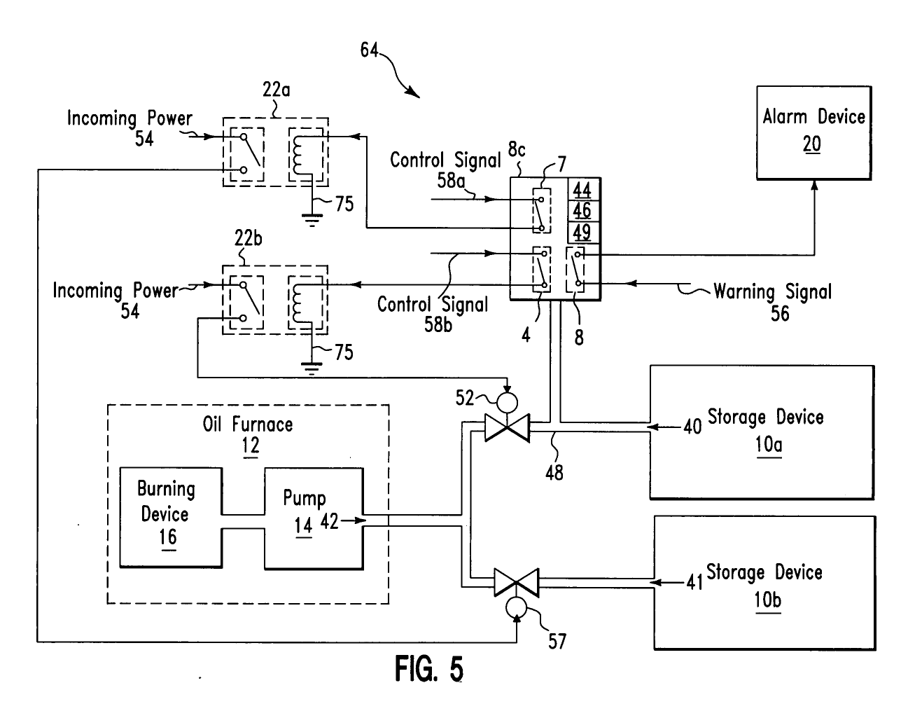

FIG. 5 illustrates a first variation of FIG. 4 depicting a block diagram of a system 64 comprising a vacuum level measurement apparatus 8c connected to the oil furnace 12, in accordance with embodiments of the present invention. In contrast with the system 60 of FIG. 4, the system 64 of FIG. 5 comprises a vacuum level measurement apparatus 8c and switching apparatus 22a and 22b. The switching apparatus 22a and 22b may comprise any switching apparatus known to a person of ordinary skill in the art including, inter alia, a relay, a contactor, etc. The system 64 allows for an oil flow from storage device 10a to be disabled and an oil flow from storage device 10b to be enabled in the event that a malfunction occurs within the storage device 10a (e.g., storage device 10a empty, clog in output 40, etc) or the fuel oil line 48 (e.g., clogged).

The switching apparatus 22a is for switching the incoming power 54 to the solenoid valve 57. The switching apparatus 22b is for switching the incoming power 54 to the solenoid valve 52. The switching apparatus 22a is normally open so that a signal path for the incoming power 54 to the solenoid 57 is disabled until the switching apparatus 22a is activated. The switching apparatus 22b is normally open so that a signal path for the incoming power 54 to the solenoid 52 is disabled until the switching apparatus 22b is activated. The switch 4 is normally closed (N/C) so that a signal path for the control signal 58b is maintained until the switch 4 is activated and the switch 7 is normally open (N/O) so that a signal path for the control signal 58a is disabled until the switch 7 is activated. Under normal conditions the control signal 58b is enabled through the normally closed switch 4. The control signal 58b activates the switching apparatus 22b so that the incoming power 54 from a fuse panel or any other power source is transmitted through the switching apparatus 22b. The incoming power 54 transmitted through the switching apparatus 22b energizes the solenoid valve 52 so that oil may flow from storage device 10a to the pump 14. The switching apparatus 22a remains open so that solenoid valve 57 remains closed thereby disabling oil flow from the storage device 10b. When a vacuum level measurement is equivalent to or exceeds the first specified vacuum level measurement set point, the switch 7 closes and the switch 4 opens. The control signal 58a is enabled to activate the switching apparatus 22a so that the incoming power 54 from a fuse panel or any other power source is transmitted through the switching apparatus 22a. The incoming power 54 transmitted through the switching apparatus 22a energizes the solenoid valve 57 so that oil may flow from storage device 10b to the pump 14. The control signal 58b is disabled thereby disabling the switching apparatus 22b so that the incoming power 54 may not be transmitted through the switching apparatus 22b. Therefore, the solenoid valve 52 is de-energized and the flow of oil from the storage device 10a to the pump 14 is disabled. Although the vacuum level measurement apparatus 8c and the switching apparatus 22a and 22b are illustrated as separate components, note that the vacuum level measurement apparatus 8c may comprise the switching apparatus 22a and 22b(i.e., the switching apparatus 22a and 22b may be built in to or a part of the vacuum level measurement apparatus 8c).

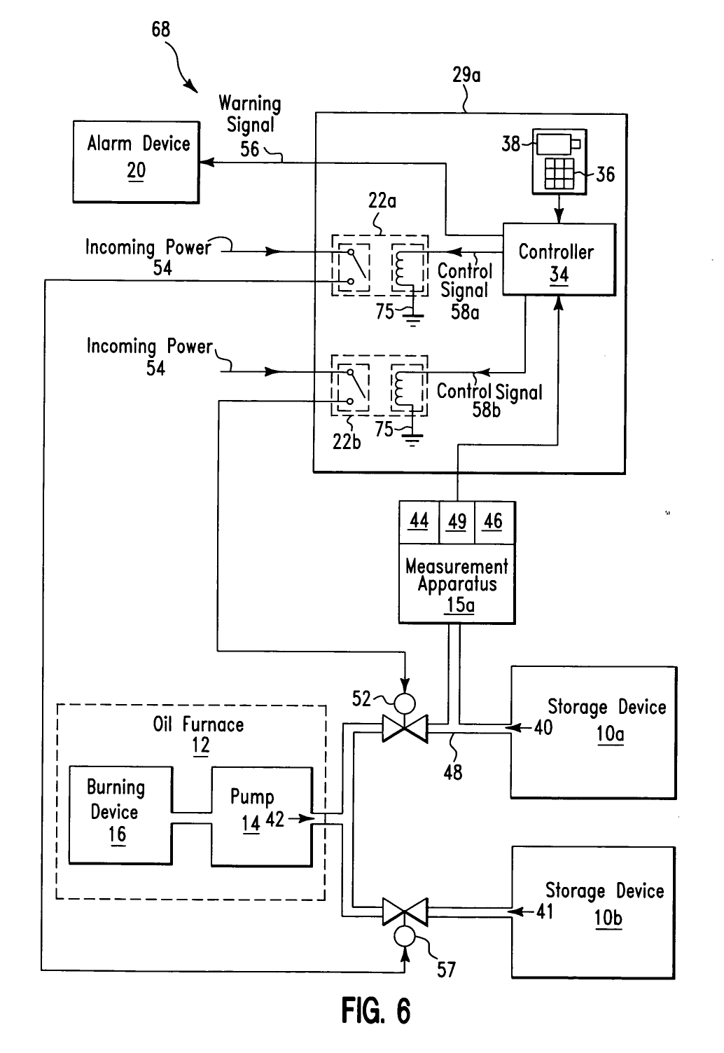

FIG. 6 illustrates a second variation of FIG. 4 depicting a block diagram of a system 68 comprising a vacuum level measurement apparatus 15a connected to the oil furnace 12, in accordance with embodiments of the present invention. In contrast with the system 60 of FIG. 4, the system 68 of FIG. 6, comprises a vacuum level measurement apparatus 15a and a control system 29a. The control system 29a comprises an input device 36, an output device 38, a controller 34, and switching apparatus 22a and 22b. The vacuum level measurement apparatus 15a and the control system 29a are in combination adapted to enable incoming power 54 to either solenoid valve 52 or solenoid valve 57 based on a specified vacuum level measurement. The control system 29a comprises a switching apparatus 22b that is normally closed (N/C) so that a signal path for the incoming power 54 to the solenoid valve 52 is maintained until the switching apparatus 22b is activated and a switching apparatus 22a that is normally open (N/O) so that a signal path for the incoming power 54 to the solenoid valve 57 is disabled until the switching apparatus 22a is activated. Under normal conditions the incoming power 54 from a fuse panel or any other power source is transmitted through the switching apparatus 22b to energize the solenoid valve 52 so that oil may flow from storage device 10a to the pump 14. The switching apparatus 22a remains open so that solenoid valve 57 remains closed thereby disabling oil flow from the storage device 10b. The controller 34 may comprise a microprocessor and a signal conditioning device (e.g., Analog/Digital converter, Digital/Analog converter, DC/DC converter, etc.). The vacuum level measurement apparatus 15a is adapted to convert a vacuum level measured by the measurement device 49 to a first electrical signal and transmit the first electrical signal to the controller 34 within the control system 29. The input device 36 and/or the input device 44 is adapted to accept and transmit a first vacuum level measurement set point to the controller 34. The controller 34 is adapted to convert the first specified vacuum level measurement set point to a second electrical signal. Additionally, the controller 34 is adapted to compare at least one level of the first electrical signal to a level of the second electrical signal and generate a first control signal 58a and a second control signal 58b when the at least one level of the first electrical signal is equivalent to or exceeds the level of the second electrical signal. The second control signal 58b activates the switching apparatus 22b which disables the incoming power 54 to the solenoid valve 52 thereby disabling a flow of oil from the storage device 10a to the pump 14. The first control signal 58a activates the switching apparatus 22a which enables the incoming power 54 to the solenoid valve 57 thereby enabling a flow of oil from the storage device 10b to the pump 14. The aforementioned steps allow for a flow of oil to be switched from the storage device 10a to the storage device 10b in the event that a malfunction is detected. The switching apparatus 22a and 22b may comprise a latching switching apparatus so that the incoming power 54 to the solenoid valve 52 remains disabled and the solenoid valve 57 remains enabled until the switching apparatus 22a and 22b are reset. If the control signal 58a and 58b are positive DC signals then a signal 75 is a DC ground or negative signal related to the control signals 58a and 58b. If the control signals 58a and 58b are hot AC signals then the signal 75 is an AC neutral signal related to the control signals 58a and 58b. The switching apparatus 22a and 22b may be any switching apparatus known to a person of ordinary skill in the art including, inter alia, a relay, a contactor, etc. The relay may be any relay known to a person of ordinary skill in the art including, inter alia, a mechanical relay, a solid state relay (SSR), a latching relay (mechanical or SSR), a timer relay (mechanical or SSR), etc. The contactor may be, inter alia, a latching contactor. The input device 36 and/or the input device 44 is further adapted to accept and transmit a second vacuum level measurement set point to the controller 34. The controller 34 is adapted to convert the second specified vacuum level measurement set point to a third electrical signal. Additionally, the controller 34 is further adapted to compare a level of the third electrical signal to the at least one level of the first electrical signal 60 and transmit a warning signal 56 to an alarm device 20 when the at least one level of the first electrical signal 60 is equivalent to or exceeds the level of the third electrical signal. The warning signal 56 activates the alarm device 20. The output device 38 is adapted to display the first vacuum level measurement set point and the second vacuum level measurement set point. The output device 38 may be any output device known to a person of ordinary skill in the art including, inter alia, a liquid crystal display (LCD), a light emitting diode (LED), a cathode ray tube (CRT), etc. The input device 36 may be any input device known to a person of ordinary skill in the art including, inter alia, a keypad, a key board, etc. The measurement device 49 may be any measurement device known to a person of ordinary skill in the art including, inter alia, a transducer, etc. The first electrical signal, the second electrical signal, and the third electrical signal may be, inter alia, a voltage signal or a current signal. Although the vacuum level measurement apparatus 15a and the control system 29a are illustrated as separate components, note that the vacuum level measurement apparatus 15a may comprise the control system 29a (i.e., the control system 29a may be built in to or a part of the vacuum level measurement apparatus 15a).

FIG. 7 illustrates an analog version of a vacuum level measurement apparatus 72, in accordance with embodiments of the present invention The vacuum level measurement apparatus 72 represents an analog example of any of the vacuum level measurement apparatuses 8, 8a, 15, 8b, 8c, and 15a of FIGS. 1-6. Connecting device 80 is adapted to connect the vacuum level measurement apparatus 72 to the fuel oil line 48 (see FIGS. 1-6). The indicators 46a and 46b represent an analog example (gauge needles) of the indicator 46 of FIGS. 1-6. The indicator 46a indicates a real time vacuum level within the fuel oil line 48. The indicator 46b indicates a peak vacuum level within the fuel oil line 48. The input device 44 represents an analog example of a device used to input a vacuum level set point(s).

FIG. 8 illustrates a digital version of a vacuum level measurement apparatus 92, in accordance with embodiments of the present invention. The vacuum level measurement apparatus 92 represents a digital example of any of the vacuum level measurement apparatuses 8, 8a, 15, 8b, 8c, and 15a of FIGS. 1-6. Connecting device 90 is adapted to connect the vacuum level measurement apparatus 92 to the fuel oil line 48 (see FIGS. 1-6). The indicator 46 indicates and displays a real time vacuum level within the fuel oil line 48. Additionally, the indicator 46 indicates a peak vacuum level within the fuel oil line 48. The input device 44 represents a digital example of a device (e.g., a keypad) used to input a vacuum level set point(s).

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. An apparatus, comprising:
a measurement device for measuring a vacuum level in a fuel oil line for an oil furnace, wherein said oil furnace comprises a pump for pumping oil into said oil furnace, and wherein said fuel oil line is located between an output of a first oil storage apparatus and an input of said pump;
a first indicator for indicating said vacuum level in said fuel oil line;
a second indicator for indicating a peak vacuum level of said vacuum level in said fuel oil line; and
an input device for accepting a first specified vacuum level measurement set point.

2. The apparatus of claim 1, further comprising:
a first switching apparatus for disabling power to said oil furnace when said vacuum level is equivalent to or exceeds said first specified vacuum level measurement set point.

3. The apparatus of claim 2, wherein said first switching apparatus comprises a first switch for enabling a control signal, and wherein said control signal is adapted to activate an electronic switch for said disabling said power to said oil furnace.

4. The apparatus of claim 3, further comprising said electronic switch.

5. The apparatus of claim 1, further comprising a first switching apparatus, wherein said first switching apparatus is for disabling a flow of oil from said first oil storage apparatus to said input of said pump when said vacuum level is equivalent to or exceeds said first specified vacuum level measurement set point, and wherein said first switching apparatus is for enabling a flow of oil from a second oil storage apparatus to said input of said pump when said vacuum level is equivalent to or exceeds said first specified vacuum level measurement set point.

6. The apparatus of claim 5, wherein said first switching apparatus comprises a first switch and a second switch, wherein said first switch is adapted to enable a first control signal, wherein said first control signal is adapted to activate a first solenoid valve for said disabling said flow of said oil from said first oil storage apparatus to said input of said pump, wherein said second switch is adapted to enable a second control signal, and wherein said second control signal is adapted to activate a second solenoid valve for said enabling said flow of said oil from said second oil storage apparatus to said input of said pump.

7. The apparatus of claim 6, further comprising a timer, wherein said timer comprises an input apparatus for accepting a specified time period, wherein said first switching apparatus comprises a third switch, and wherein said timer is adapted to maintain the second switch and the third switch in an open position for said specified time period.

8. The apparatus of claim 1, further comprising:
a first switching apparatus for enabling a warning signal for an alarm when said vacuum level is equivalent to or exceeds said first specified vacuum level measurement set point.

9. The apparatus of claim 8, further comprising:
a second switching apparatus, wherein said input device is for accepting a second specified vacuum level measurement set point, and wherein said second switching apparatus is for disabling power to said oil furnace when said vacuum level is equivalent to or exceeds said second specified vacuum level measurement set point.

10. The apparatus of claim 8, further comprising:
a second switching apparatus comprising a first switch and a second switch, wherein said input device is for accepting a second specified vacuum level measurement set point, wherein said first switch is for disabling a flow of oil from said first oil storage apparatus to said input of said pump when said vacuum level is equivalent to or exceeds said second specified vacuum level measurement set point, and wherein said second switch is for enabling a flow of oil from a second oil storage apparatus to said input of said pump when said vacuum level is equivalent to or exceeds said second specified vacuum level measurement set point.

11. The apparatus of claim 1, further comprising:
a control system, wherein said measurement device is adapted to convert said vacuum level into a first electronic signal, wherein said control system comprises a controller and a switching device, wherein said controller is adapted to convert said first specified vacuum level measurement set point into a second electronic signal, wherein said controller is further adapted to compare at least one level of said first electronic signal with a level of said second electronic signal and transmit a control signal when said at least one level of said first electronic signal is equivalent to or exceeds said level of said second electronic signal, and wherein said control signal is adapted to activate said switching device to disable power to said oil furnace.

12. The apparatus of claim 1, wherein said apparatus comprises an analog apparatus.

13. The apparatus of claim 1, wherein said apparatus comprises a digital apparatus.

14. The apparatus of claim 1, wherein said apparatus further comprises said oil furnace.

15. A method, comprising:
providing an apparatus comprising, a measurement device, a first indicator, a second indicator, and an input device;
measuring, by said measurement device, a vacuum level in a fuel oil line for an oil furnace, wherein said oil furnace comprises a pump for pumping oil into said oil furnace, and wherein said fuel oil line is located between an output of a first oil storage apparatus and an input of said pump;
indicating by said first indicator, said vacuum level in said fuel oil line;
indicating, by said second indicator, a peak vacuum level of said vacuum level in said fuel oil line; and
accepting, by said input device, a first specified vacuum level measurement set point.

16. The method of claim 15, wherein said apparatus further comprises a first switching apparatus, and wherein said method further comprises:
disabling, by said switching apparatus, power to said oil furnace when said vacuum level is equivalent to or exceeds said first specified vacuum level measurement set point.

17. The method of claim 16, wherein said first switching apparatus comprises a first switch, and wherein said method further comprises:
enabling, by said first switch, a control signal; and
activating, by said control signal, an electronic switch for said disabling said power to said oil furnace.

18. The method of claim 17, wherein said apparatus further comprises said electronic switch.

19. The method of claim 15, wherein said apparatus further comprises a first switching apparatus, and wherein said method further comprises:
disabling, by said first switching apparatus, a flow of oil from said first oil storage apparatus to said input of said pump when said vacuum level is equivalent to or exceeds said first specified vacuum level measurement set point; and
enabling, by said first switching apparatus, a flow of oil from a second oil storage apparatus to said input of said pump when said vacuum level is equivalent to or exceeds said first specified vacuum level measurement set point.

20. The method of claim 19, wherein said first switching apparatus comprises a first switch and a second switch, and wherein said method further comprises:
enabling, by said first switch, a first control signal;
activating, by said first control signal, a first solenoid valve for said disabling said flow of said oil from said first oil storage apparatus to said input of said pump;
enabling, by said second switch, a second control signal; and
activating, by said second control signal, a second solenoid valve for said enabling said flow of said oil from said second oil storage apparatus to said input of said pump.

21. The method of claim 15, wherein said apparatus further comprises a first switching apparatus, and wherein said method further comprises:
enabling, by said first switching apparatus, a warning signal for an alarm when said vacuum level is equivalent to or exceeds said first specified vacuum level measurement set point.

22. The method of claim 21, wherein said apparatus further comprises a second switching apparatus, and wherein said method further comprises:
accepting, by said input device, a second specified vacuum level measurement set point; and
disabling, by said second switching apparatus, power to said oil furnace when said vacuum level is equivalent to or exceeds said second specified vacuum level measurement set point.

23. The method of claim 21, wherein said apparatus further comprises a second switching apparatus comprising a first switch and a second switch, and wherein said method further comprises:
accepting, by said input device, a second specified vacuum level measurement set point;
disabling, by said first switch, a flow of oil from said first oil storage apparatus to said input of said pump when said vacuum level is equivalent to or exceeds said second specified vacuum level measurement set point; and
enabling, by said second switch, a flow of oil from a second oil storage apparatus to said input of said pump when said vacuum level is equivalent to or exceeds said second specified vacuum level measurement set point.

24. The method of claim 15, wherein said apparatus further comprises a control system, wherein said control system comprises a controller and a switching device, and wherein said method further comprises:
converting, by said measurement device, said vacuum level into a first electronic signal;
converting, by said controller, said first specified vacuum level measurement set point into a second electronic signal;
comparing, by said controller, at least one level of said first electronic signal with a level of said second electronic signal;
transmitting by said controller, a control signal when said at least one level of said first electronic signal is equivalent to or exceeds said level of said second electronic signal; and
activating, by said control signal, said switching device to disable power to said oil furnace.

25. The method of claim 15, wherein said apparatus comprises an analog apparatus.

26. The method of claim 15, wherein said apparatus comprises a digital apparatus.

27. The method of claim 15, wherein said apparatus further comprises said oil furnace.
